(19) United States
(12) Patent Application Publication
(10) Pub. No.: US 2008/0102855 A1
(43) Pub. Date: May 1, 2008

(54) Location Mapping of Federated Devices

(75) Inventors: Scott C. Forbes, Redmond, WA (US); Gregory P. Baribault, Lynnwood, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/554,471

(22) Filed: Oct. 30, 2006

(51) Int. Cl. H04Q 7/20

(52) U.S. Cl. 455/456.1

(57) ABSTRACT

The present invention provides technologies for mapping the locations of federated devices, such as their physical locations. Individuals carrying mobile devices on their person may make use of such devices to determine their relative physical location or the relative physical location of others carrying such devices, such as family or friends. Such devices may send out relative and/or absolute location information to other devices in a federation or the like, such information being used to create a map of relative and/or absolute locations of the devices. Typically, the more devices that send out location information, the more accurate the location mapping. If one or more of the devices is able to provide absolute location information, such as longitude, latitude, altitude, or the like, then the mapping may include absolute locations of at least some of the devices accurate to some degree.

### BACKGROUND

With the proliferation of mobile electronic devices, an increasing number of individuals carry one or more such devices on their person regularly. Such devices may include location-finding technologies such as global positioning system (“GPS”) receivers or the ability to obtain information useful for location determination via subscriber network triangulation or the like. Such mobile devices may also include communications means suitable for establishing federations of devices, ad-hoc networks, peer-networks, wireless connectivity with service networks and providers, and the like, and exchanging location information with other devices.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present invention provides technologies for mapping the locations of federated devices, such as physical location. Individuals carrying mobile devices on their person may make use of such devices to determine their relative physical location or the relative physical location of others carrying such devices, such as family or friends. Such devices may send out relative and/or absolute location information to other devices in a federation or the like, such information being used to create a map of relative and/or absolute location of the devices. Typically, the more devices that send location information, the more accurate the location mapping. If one or more of the devices is able to provide absolute location information, such as longitude, latitude, altitude, or the like, then the mapping may include absolute locations of at least some of the devices accurate to some degree.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a block diagram showing example mobile devices coupled to together via a network and to a location mapping (“LM”) server and database or LM data store.

FIG. 2 is a block diagram showing example mobile devices coupled together via an ad-hoc network.

FIG. 3 is a diagram showing a representation of several example persons, each carrying an example mobile device, the persons located relative to each other in a particular area.

FIG. 4 is a bock diagram showing example data structures for use in location mapping.

FIG. 5 is a block diagram showing an example location mapping system.

FIG. 6 is a block diagram showing an example method for creating and updating a local location table data structure.

FIG. 7 is a block diagram showing an example method for creating and updating a map.

FIG. 8 is a block diagram showing an example computing environment in which the technologies described above may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a computing and networking environment, the technologies and methods described are provided as examples and not limitations. As those skilled in the art will appreciate, the present examples are suitable for application in a variety of different types of computing and networking environments.

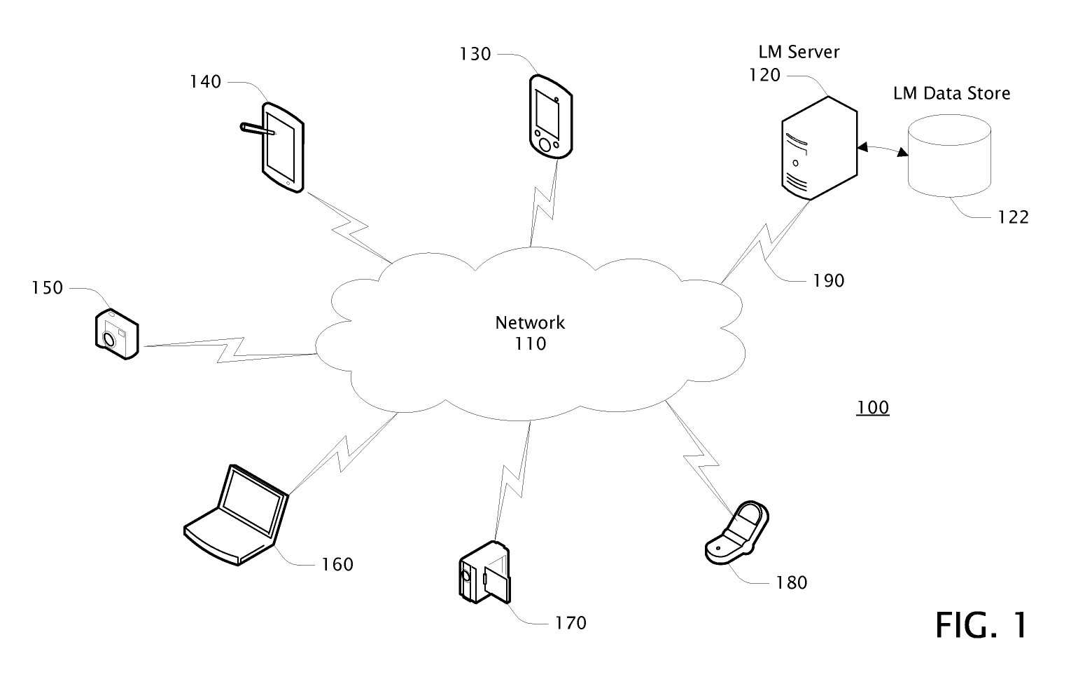

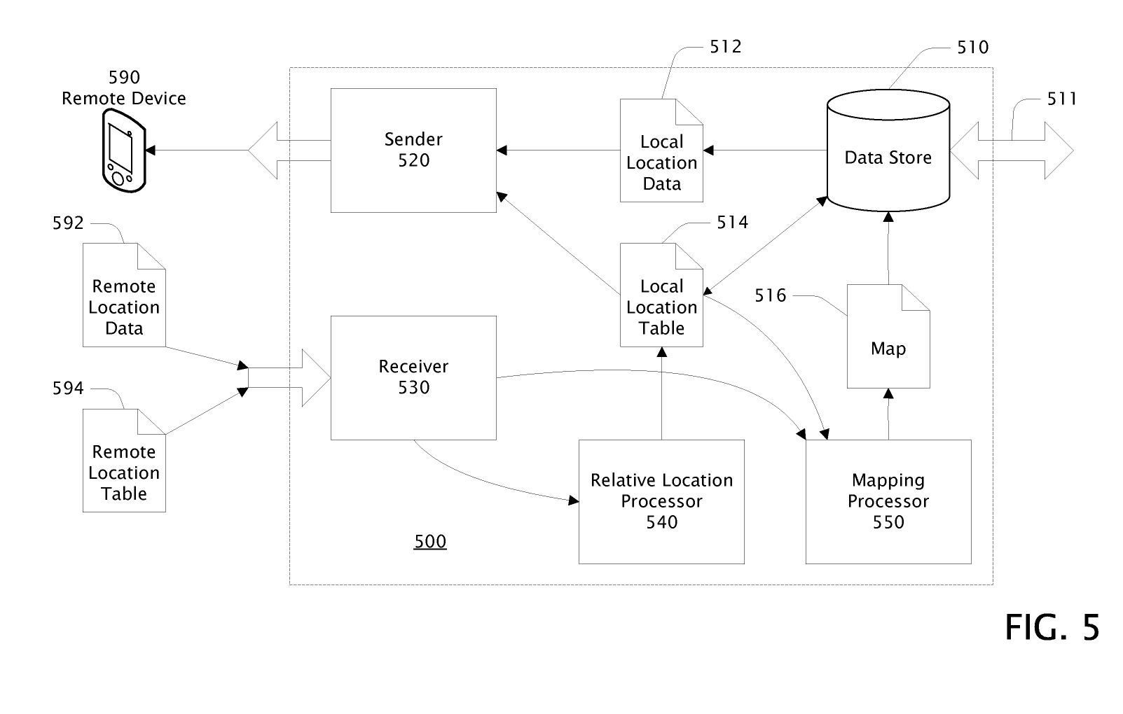

FIG. 1 is a block diagram showing example mobile devices coupled to together via a network 110 and to a location mapping (“LM”) server 120 and database or LM data store 122. Example devices may include personal data assistant (“PDA”) 130, tablet personal computer (“PC”) 140, digital camera 150, laptop PC 160, digital video recorder (“DVR”) 170, and cell phone 180. Such devices should be operable to at least send and receive location data, recognize and/or support device location mapping information. Some such devices may include an example computing environment such as that described in connection with FIG. 5. Many other devices may also be coupled via network 110 or other means, including a watch including appropriate location mapping functionality, a security bracelet or the like, or any other device for which location mapping functionality may be of value. Such devices may include mobile devices or other devices such as desktop PCs, servers, systems, or any other type of mobile or non-mobile device that may contribute to and/or benefit from location mapping. Further examples of such devices include vehicles or any other device, system, construct, composition, or the like operable to at least send and/or receive, recognize and/or support location mapping information.

Devices may be coupled to network 110 via any operable link, such as example link 190. Such links may include a network interface card (“NIC”), a serial or parallel port, a data bus, an analog interface, or the like, may be wired or wireless, may make use of infrared (“IR”), acoustics, optics, radios frequency (“RF”), or the like. Network 110 may be an ad-hoc network with mobile devices coupling transiently. Server devices, such as server 120, and other non- or less-mobile devices, may be coupled to network 110 more persistently than mobile devices. In one example, network 110 may be a wireless fidelity (“Wi-Fi”) network at a municipal facility, coffee shop, city library, courtroom, or airport lounge. Mobile and other devices may typically link to such a Wi-Fi network via wireless adapters. Such devices may also be operable to link to other types of networks. In another example, cell phones may link to a cellular network via appropriate RF adapters and protocols. Such cell phones may also be operable to link to other types of networks, such as Wi-Fi networks or the like.

LM server 120 may send and receive location information to other devices coupled to network 110 and may process such location information and create location tables, maps, or the like, and may send such location tables and/or maps or other location information to other devices coupled to network 110. LM data store 122 may be utilized by LM server 120 to store location data, locations tables, and/or location maps or the like including such received from various devices coupled to network 110. In one example, LM server 120 and database 122 may be a LM appliance—a special-purpose device or system or the like primarily intended to provide LM server and/or database functionality. Such a LM appliance may be coupled to network 110 via any operable link, such as example link 190. Alternatively, a LM appliance may provide a subset of LM server and database functionality and/or may not be coupled to a network. Such an appliance may simply emit location information via RF means or acoustic means or the like. An example of such an appliance may be a GPS satellite, location transponder, or the like.

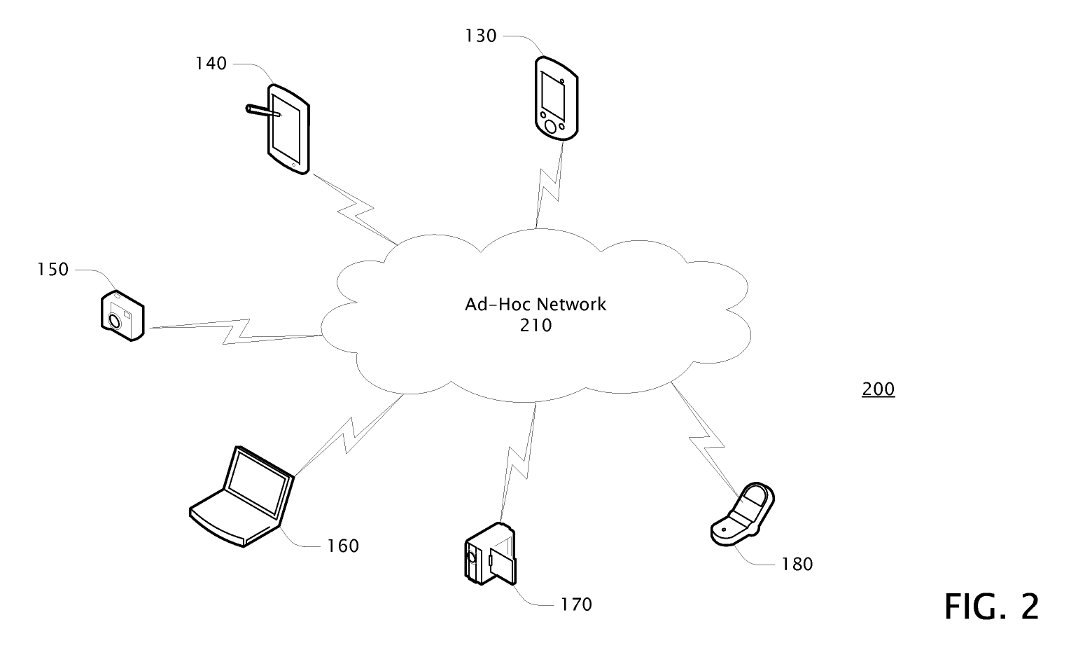

FIG. 2 is a block diagram showing example mobile devices coupled together via an ad-hoc network 210. Such an ad-hoc network may not include any persistent devices such as LM servers or related data stores. Ad-hoc networks for LM purposes may be formed as various mobile devices dynamically form and join such networks. For example, an ad-hoc network may be formed comprising devices of people on a particular bus or in a particular office, building, or area. In another example, such an ad-hoc network may be formed comprising devices carried by members of a particular family and perhaps their friends, by members of a club, group, association, or the like, by employees of a company, etc. Example devices shown in FIG. 2 include those described in connection with FIG. 1.

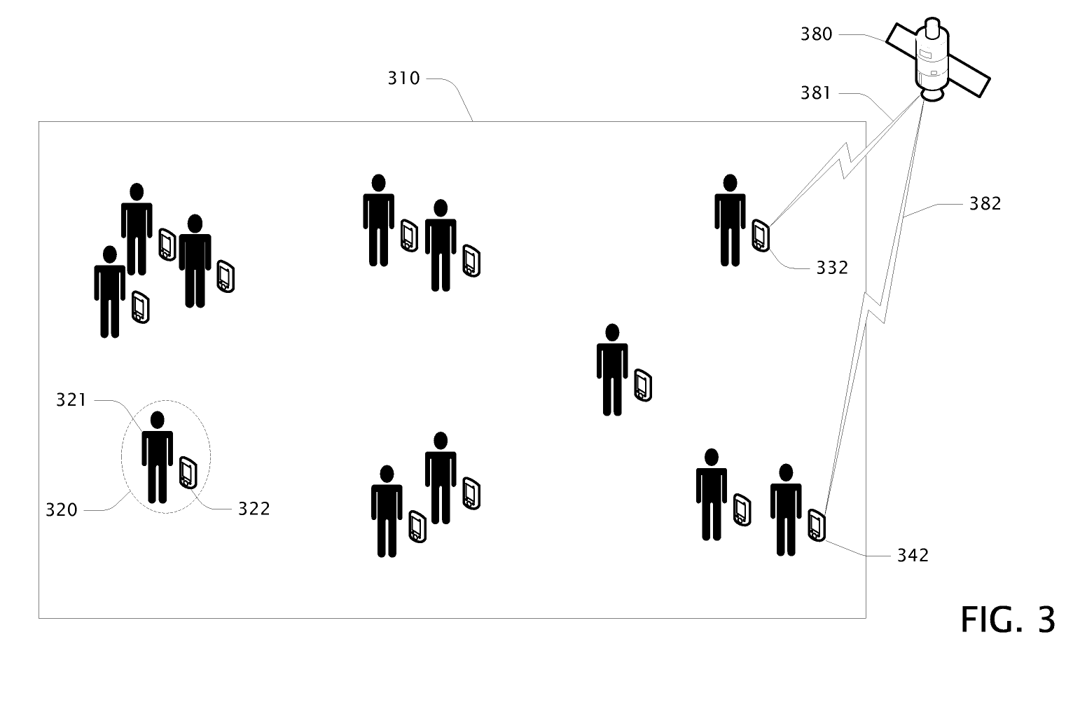

FIG. 3 is a diagram showing a representation of several example persons, each carrying an example mobile device, the persons located relative to each other in a particular area 310. Location mapable entity (“LME”) 320 is comprised of person 321 and device 322, the association between person 321 and device 322 emphasized by the dashed oval of LME 320. Several other example LMEs, persons associated with devices, are shown in area 310 without emphasizing ovals. In other examples, rather than persons associated with a device, LMEs may be include animals, vehicles, packages, facilities, or any other objects or combination of the foregoing or the like for which location mapping may be of value.

Example area 310 may be an office, room, home, building, locale, zone, or any other physical region or the like or combination of such, well defined or abstract, in which the devices of two or more LMEs may communicate one with another either periodically or continuously. Such an area may be relatively small, such as an office or street, or relatively large, such as a country or the world. Communications between devices may take place via any coupling means, such as links to a wireless network or RF, IR, acoustic, wired, or other links sufficient to provide a communications means between devices. Such communication means may include the Internet, wireless subscriber networks, corporate networks, or the like. A federation of LMEs may be established via such communication means through the formation of an ad-hoc network or the like. The federated LMEs may perform location mapping among themselves. An LME may be included in more than one federation and inclusion in a federation may be of a transient nature.

One or more LME devices may obtain absolute location information, such as example devices 332 and 342 shown receiving GPS data exemplified by links 381 and 382 with example GPS satellite 380. Devices may obtain absolute location information via any sufficient means including GPS, subscriber network triangulation, tracking tags, or the like. Absolute location information may include two dimensional or three dimensional data. Such absolute location information may be utilized by a federation of devices to perform absolute location mapping of the devices with some degree of accuracy. Absolute location data is generally not required for relative location mapping, that is, the mapping of federated LMEs relative to one another.

A federation of devices is generally intended herein to mean a grouping, collection, partnership, association, coalition, or the like of devices such that the devices may collaborate, interact, communicate, or the like via some means and for some purpose. In particular, a federation of such devices may interact for location mapping purposes. A federated device is generally a device that is part of a federation of devices. Such as device may federate with other devices briefly or for a longer period of time. A federation of devices may be established via some formal means or via some ad-hoc means. The devices of such a federation of devices may collaborate, interact, communicate, or the like via a means such as a network, ad-hoc network, virtual network, RF transmissions, acoustics, IR, any other suitable means, or any combination of the foregoing.

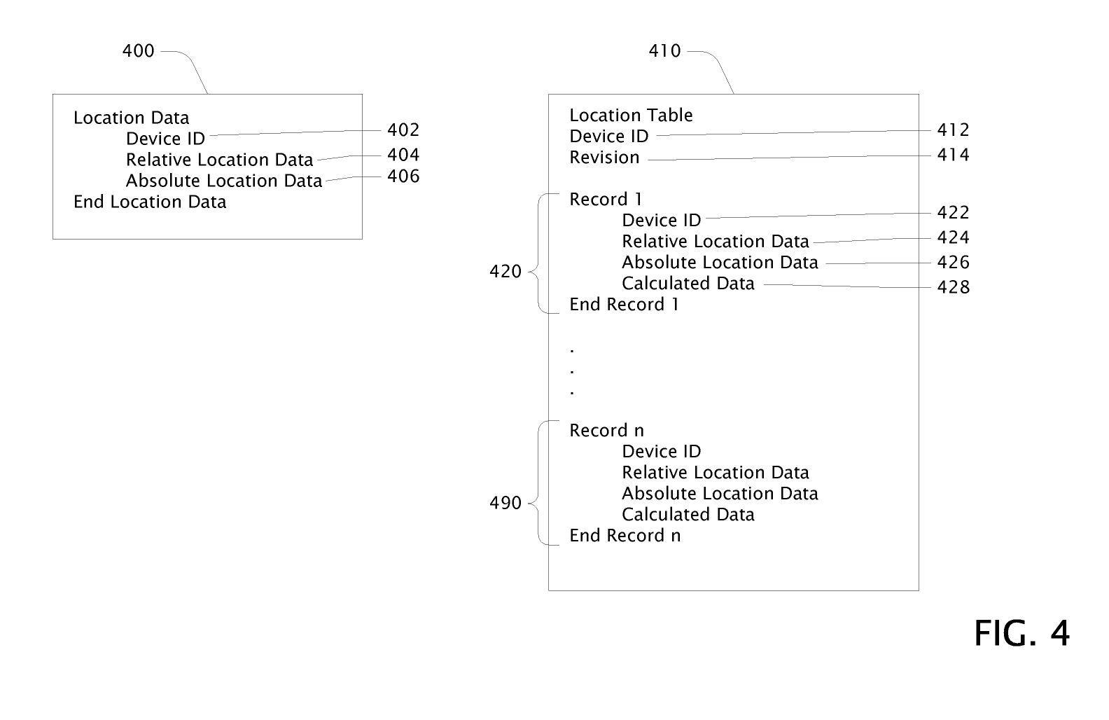

FIG. 4 is a bock diagram showing example data structures 400 and 410 for use in location mapping. Such data structures may be embodied in various forms, syntaxes, structures, or the like, suitable for location mapping purposes including maintaining, storing, and/or processing location mapping data and/or communicating location mapping data with other devices. Such data structure may include records. The term record as used herein generally refers to a data structure or the like that includes one or more data elements or fields organized in some defined manner. A data structure, such as data structures 400 and 410, may include multiple records with each such record typically being discernable from any other records.

In one example, data structures 400 and 410 may be embodied using extensible markup language (“XML”) or the like. In another example, such data structures may be embodied in the syntax of a programming language such as C++ or the like. In yet another example, such data structures may be embodied in a data base table or the like. Alternatively, such data structures may be embodied in a combination of the foregoing or the like. Such data structures may be embodied in any computer-readable format and/or stored in/on any computer-readable media.

Example location data (“LD”) data structure 400 may be used by a device to send, transmit, broadcast, or otherwise communicate location information to other devices. LD data structure 400 typically includes device identification (“ID”) field 402 containing information that uniquely identifies the device sending the LD data structure. In one example, device ID field 402 contains a global unique identifier (“GUID”) that uniquely identifies the device from among other devices in a federation of devices. In other examples, other forms of device ID information, such as address information, may be used appropriate to uniquely identifying the device from among other devices in a federation of devices.

LD data structure 400 typically includes relative location data field 404 containing information that identifies the location of the sending device relative to a receiving device. For example, field 404 may include information usable by a receiving device to calculate a form of relative location of the sending device to the receiving device. In one example, field 404 may include transmission signal strength information or the like that may be used in conjunction with received signal strength to calculate an approximate distance of the sending device from the receiving device.

LD data structure 400 optionally includes absolute location data field 406 containing absolute location information for the sending device. For example, field 406 may include latitude, longitude, and altitude information or the like for the sending device, such as obtainable via GPS or other absolute location determination mechanisms.

LD data structure 400 may include other fields and/or information useful in communication with other devices and in communicating location information with other devices. Such other information may include additional location information, address information, communication headers, check sums, time stamps, revision information, or the like.

Example location table (“LT”) data structure 410 may be used by an owning device—the device responsible for, that creates and utilizes the LT data structure—to collect and store information received from other devices and/or calculated using information received from other devices. LT data structure 410 may also be used by an owning device to send, transmit, broadcast, or otherwise communicate location information to other devices. LT data structure 410 typically includes device identification (“ID”) field 412 containing information that uniquely identifies the device that owns the LT data structure. In one example, device ID field 412 contains a global unique identifier (“GUID”) that uniquely identifies the owning device from among other devices in a federation of devices. In other examples, other forms of device ID information, such as address information, may be used to uniquely identifying the device from among other devices in a federation of devices.

LT data structure 410 typically includes revision field 414 containing revision information for LT data structure 410. Such revision information may be used by devices to properly interpret the data in such a received LT data structure.

LT data structure 410 typically includes a record for each device from which location information has been received, such as Record 1 and Record n, 420 and 490 respectively. In one example, each record includes device ID field 422, relative location data field 424, and absolute location data field 426, each field containing the corresponding information from a LD data structure received from a sending device. Further, each record includes calculated data field 428 that contains calculated relative location information that identifies the location of the sending device relative to the device that owns the LT data structure. In one example, such calculated relative location information includes a bearing and a distance relative to the device that owns the LT data structure.

FIG. 5 is a block diagram showing an example location mapping (“LM”) system 500. LM system 500 may be implemented in software, hardware, firmware, or the like, or any combination of the foregoing. LM system 500 typically operates on a device such as an LME device. Alternatively, LM system 500 may be a distributed system with the various elements operating on various devices or the like. LM system 500 is comprised of elements including data store 510, sender 520, receiver 530, relative location processor 540, and mapping processor 550. LM system 500 also utilizes data structures including local location data (“LLD”) data structure 512 (may be equivalent to LD data structure 400 described in connection with FIG. 4), local location table (“LLT”) data structure 514 (may be equivalent to LT data structure 410 described in connection with FIG. 4), and map data structure 516. The arrows shown in FIG. 5 represent example interactions and communications between elements of LM system 500. Other interactions and communications may also exist between such elements that may not be represented by arrows.

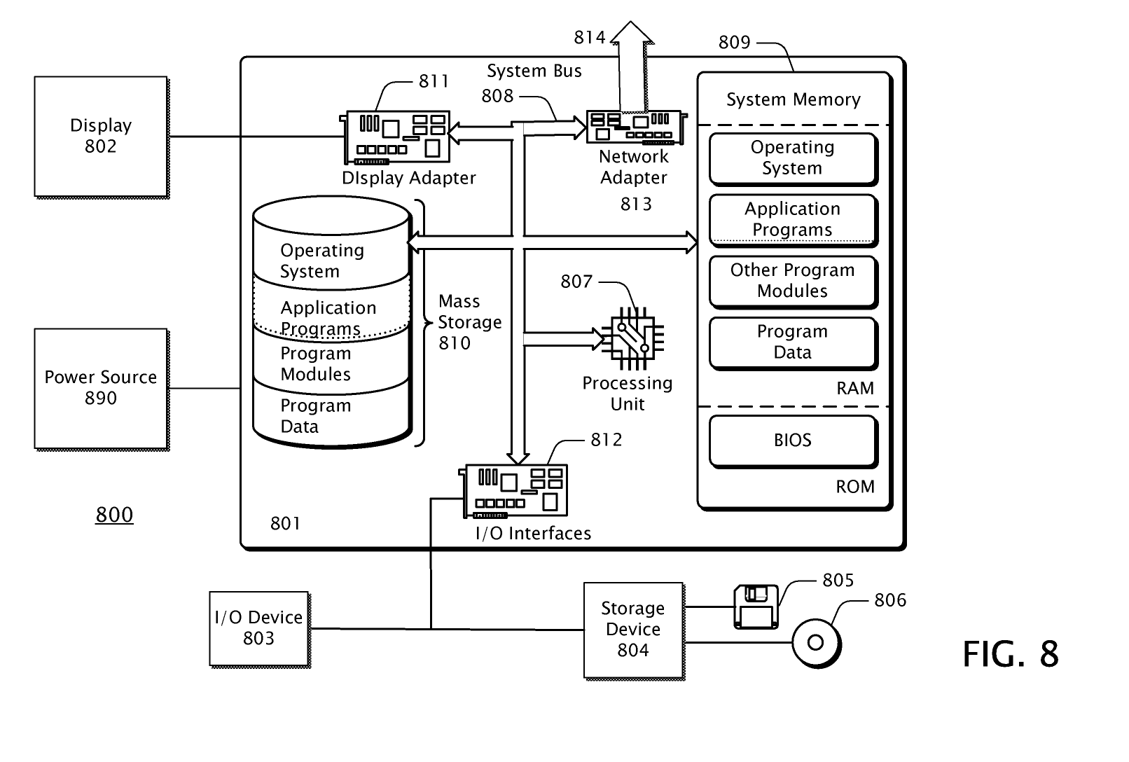

Example data store 510 is a mechanism sufficient to store location mapping data structures, such as data structures 512, 514, and 516, as well as any other location mapping data. Data store 510 may be volatile or non-volatile and may include system memory and/or mass storage such as described in connection with FIG. 8. Data store 510 may be local to an LME device or remotely located and accessed via communication media.

Example sender 520 is a means for sending, transmitting, broadcasting, or the like, location mapping information, such as LLD 512 and LLT 514 data structures, and/or other information or data to other devices. Such sending may be to specific other devices, to all devices in a federation of devices, to some other subset of devices, or to any device without limitation. In one example, sender 520 is a network interface that may be coupled to one or more networks. LM system 500 may send data structures, such as LLD 512 and LLT 514 data structures, and/or other information, via sender 520 to other devices, such as remote device 590.

Example receiver 530 is a means for receiving, accepting, obtaining, or the like location mapping information, such as remote location data (“RLD”) 592 and remote location table (“RLT”) 594 data structures, and/or other information or data from other devices. RLD 592 and RLT 594 data structures may be equivalent to LD 400 and LT 410 data structures respectively described in connection with FIG. 4. Such receiving may be from specific other devices, from all devices in a federation of devices, from some other subset of devices, or from any device without limitation. In one example, receiver 530 is a network interface that may be coupled to one or more networks. LM system 500 may receive data structures, such as RLD 592 and RLT 594 data structures, and/or other information, via receiver 530 from other devices, such as remote device 590. Data structures and/or other information received by receiver 530 may be provided to relative location processor 540 and/or mapping processor 550.

Example relative location processor (“RLP”) 540 is a means for processing received RLD 592 and RLT 594 data structures and/or other information in order to, among other things, create and/or update LLT data structure 514. When LLT data structure 514 is created and/or updated by RLP 540, it also may be sent to other devices via sender 520, may be stored in data store 510, and may be provided to mapping processor 550. In one example, RLP 540 processes RLD data structures received from other devices and builds LLT data structure 514 with a record including the information from each RLD data structured received from each distinct device. Further, RLP 540 may calculate relative location information based on the received RLD data structures and fills in the calculated data field of each record, such as calculated data field 428 described in connection with FIG. 4.

Example mapping processor (“MP”) 550 is a means for processing LLT data structure 514 and/or other information in order to, among other things, create and/or update map data structure 516. When map data structure 516 is created and/or updated by MP 550, it may also be stored in data store 510, and may be used to display a relative location map and/or provide relative and/or absolute location information regarding devices represented in LLT data structure 514 as indicated by arrow 511.

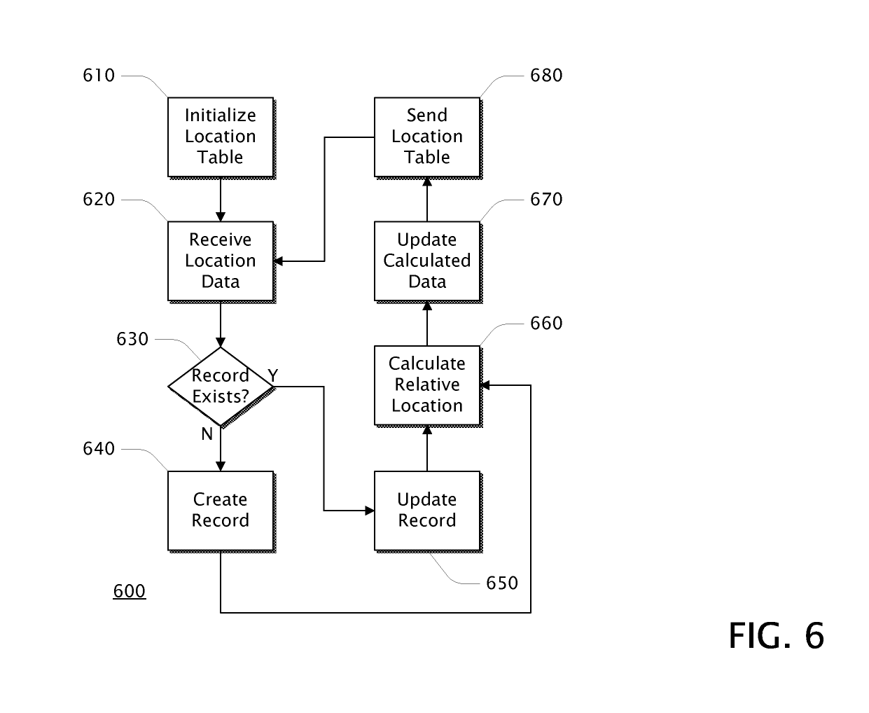

FIG. 6 is a block diagram showing an example method 600 for creating and updating a local location table (“LLT”) data structure. The example LLT data structure may be similar or equivalent to example LT data structure 410 described in connection with FIG. 4. Typically, each LME device creates and updates such an LLT data structure 410 for each federation of devices in which it is involved in location mapping. For purposes of clarity, method 600 is described in relation to example data structures 400 and 410 of FIG. 4.

Block 610 indicates the initial creation and initialization of LLT data structure 410 including filling in the device ID and revision fields 412 and 414 respectively, as well as any other initialization required for use in location mapping. Device ID field 412 is typically filled in with the device ID of the owning device—the LME device that owns LLT data structure 410. Once LLT data structure 410 is initialized, method 600 continues at block 620.

Block 620 indicates the owning device receiving an example RLD data structure from one or more other devices. The example RLD data structure may be similar or equivalent to example LD data structure 400 described in connection with FIG. 4. For each RLD data structure 400 received, method 600 continues at block 630.

Block 630 indicates a test to determine if the device ID field 402 of received RLD data structure 400 matches that of any record, such as example record 420, in LLT data structure 410. If there is a match, then at least one previous RLD data structure 400 has been received from the device identified in device ID field 402 and a corresponding record has already been created in LLT data structure 410, and method 600 continues at block 650. If there is not a match, then method 600 continues at block 640.

Block 640 indicates the creation of a record, such as example record 420, in LLT data structure 410 corresponding to the received RLD data structure 400. Such record creation typically includes copying information from the device ID 402, relative location data 404, and absolute location 406 data fields of received RLD data structure 400 to corresponding fields 422, 424, and 426 respectively of LLT data structure 410 of the owning device. Once the record is created, method 600 continues at block 660.

Block 650 indicates updating a record, such as example record 420, in LLT data structure 410 corresponding to the received RLD data structure 400. Such record updating typically includes copying information from the relative location data 404 and absolute location 406 data fields of received RLD data structure 400 to corresponding fields 424, and 426 respectively of LLT data structure 410 of the owning device. Once the record is updated, method 600 continues at block 660.

Block 660 indicates calculating the relative location of the sending device. For example, the owning device/receiving device may calculate the location of the device that sent the received RLD data structure 400 relative to the receiving device. This calculation may be performed using data from the received RLD data structure 400 and/or any other data suitable for such purposes. In one example, the relative location calculation is made using a measurement of the signal strength of the received RLD data structure 400 compared to the transmitted signal strength indicated in the relative location data field 404 of the received RLD data structure 400. Alternatively or additionally, other suitable methods and/or data may be used to calculate the location of the sending device relative to the receiving device. Once the relative location is calculated, method 600 continues at block 670.

Block 670 indicates updating the record with the latest calculated relative location data. In one example, the owning device records the result of the relative location calculation in the calculated data field 428 of the LLT data structure 410. Once the record is updated, method 600 continues at block 680.

Block 680 indicates sending the created and/or updated LLT data structure 410 to other devices. Such sending may occur every time data structure 410 is created and/or updated, on a particular interval, when a particular number of records have been created and/or updated, on any combination of the foregoing, or on any other schedule, interval, condition, or the like. Method 600 continues at block 620 waiting for another RLD data structure 400 to be received.

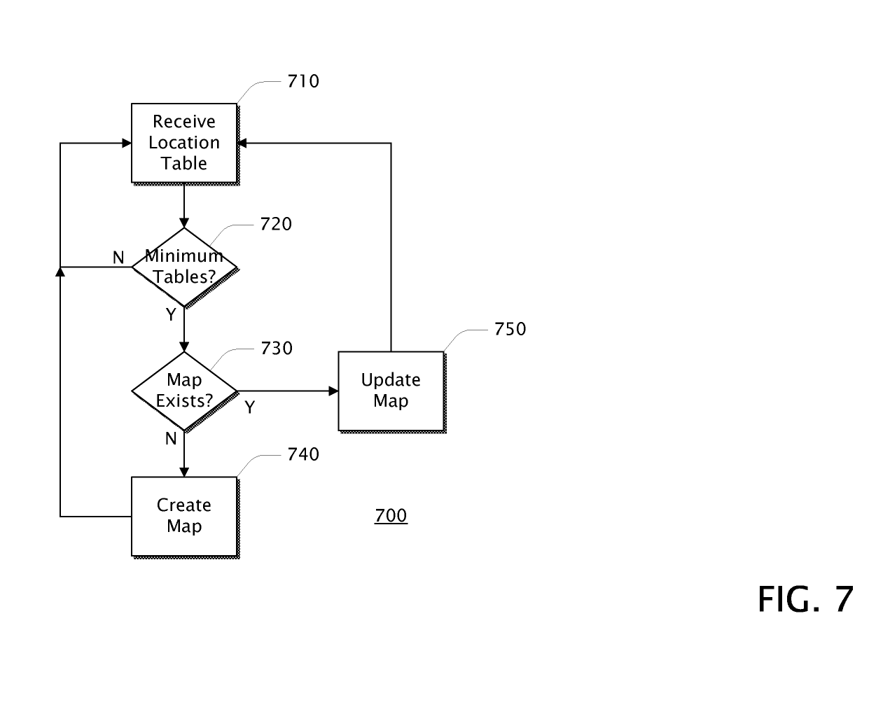

FIG. 7 is a block diagram showing an example method 700 for creating and updating a map. Typically, each LME device creates and updates a map for each federation of devices in which it is involved in location mapping. For purposes of clarity, method 700 is described in relation to example data structure 410 of FIG. 4.

Block 710 indicates the owning device receiving an example RLT data structure from one or more other devices. The example RLT data structure may be similar or equivalent to example LT data structure 410 described in connection with FIG. 4. For each RLT data structure 410 received, method 700 continues at block 720.

Block 720 indicates a test to determine if the owning device/receiving device has received enough RLT data structures to create a map of devices in the federation of devices. If no, the method 700 continues at block 710 waiting to receive additional RLT data structures. If yes, then method 700 continues at block 730.

Block 730 indicates a test to determine if the receiving device has already created a map. If no, method 700 continues at block 740. If yes, method 700 continues at block 750.

Block 740 indicates creating a map. For example, the receiving device may make use of the required minimum number of received RLT data structures 410 and/or its own LLT data structure 410 to create a map. Such a map is typically created as a data structure suitable to graphically render the map on a display. In one example, triangulation calculations are performed using calculated relative location data 428 from the received RLT data structures 410 and the LLT data structure 410 to create the map. Such a map typically indicates the locations of the various LME devices relative to one another. Should absolute location data 426 be available for one or more of the devices in the LLT and RLT data structures 410, the map may also indicate absolute location information for one or more of the devices in the map. Once a map is created, method 700 continues at block 710 waiting for additional RLT data structures 410 to be received such that the map can be further updated.

Block 750 indicates updating the map. For example, the receiving device may make use of the required minimum number of received RLT data structures 410 and/or its own LLT data structure 410 to update the map. Such an update may result in indicating the relative location of one or more devices not previously indicated by the map, and/or in updating the relative location of one or more previously indicated devices. Such an update may also result in eliminating a device previously indicated by the map, such as when a device is no longer part of a federation of devices involved in location mapping. Once the map is updated, method 700 continues at block 710 waiting for additional RLT data structures 410 to be received such that the map can be further updated.

FIG. 8 is a block diagram showing an example computing environment 800 in which the technologies described above may be implemented. A suitable computing environment may be implemented with numerous general purpose or special purpose systems. Examples of well known systems may include, but are not limited to, cell phones, personal digital assistants (“PDA”), personal computers (“PC”), hand-held or laptop devices, microprocessor-based systems, multiprocessor systems, servers, workstations, consumer electronic devices, set-top boxes, and the like.

Computing environment 800 typically includes a general-purpose computing system in the form of a computing device 801 coupled to various components, such as peripheral devices 802, 803, 804 and the like. System 800 may couple to various other components, such as input devices 803, including voice recognition, touch pads, buttons, keyboards and/or pointing devices, such as a mouse or trackball, via one or more input/output (“I/O”) interfaces 812. The components of computing device 801 may include one or more processors (including central processing units (“CPU”), graphics processing units (“GPU”), microprocessors (“μP”), and the like) 807, system memory 809, and a system bus 808 that typically couples the various components. Processor 807 typically processes or executes various computer-executable instructions to control the operation of computing device 801 and to communicate with other electronic and/or computing devices, systems or environment (not shown) via various communications connections such as a network connection 814 or the like. System bus 808 represents any number of several types of bus structures, including a memory bus or memory controller, a peripheral bus, a serial bus, an accelerated graphics port, a processor or local bus using any of a variety of bus architectures, and the like.

System memory 809 may include computer readable media in the form of volatile memory, such as random access memory (“RAM”), and/or non-volatile memory, such as read only memory (“ROM”) or flash memory (“FLASH”). A basic input/output system (“BIOS”) may be stored in non-volatile or the like. System memory 809 typically stores data, computer-executable instructions and/or program modules comprising computer-executable instructions that are immediately accessible to and/or presently operated on by one or more of the processors 807.

Mass storage devices 804 and 810 may be coupled to computing device 801 or incorporated into computing device 801 via coupling to the system bus. Such mass storage devices 804 and 810 may include non-volatile RAM, a magnetic disk drive which reads from and/or writes to a removable, non-volatile magnetic disk (e.g., a “floppy disk”) 805, and/or an optical disk drive that reads from and/or writes to a non-volatile optical disk such as a CD ROM, DVD ROM 806. Alternatively, a mass storage device, such as hard disk 810, may include non-removable storage medium. Other mass storage devices may include memory cards, memory sticks, tape storage devices, and the like.

Any number of computer programs, files, data structures, and the like may be stored in mass storage 810, other storage devices 804, 805, 806 and system memory 809 (typically limited by available space) including, by way of example and not limitation, operating systems, application programs, data files, directory structures, computer-executable instructions, and the like.

Output components or devices, such as display device 802, may be coupled to computing device 801, typically via an interface such as a display adapter 811. Output device 802 may be a liquid crystal display (“LCD”). Other example output devices may include printers, audio outputs, voice outputs, cathode ray tube (“CRT”) displays, tactile devices or other sensory output mechanisms, or the like. Output devices may enable computing device 801 to interact with human operators or other machines, systems, computing environments, or the like. A user may interface with computing environment 800 via any number of different I/O devices 803 such as a touch pad, buttons, keyboard, mouse, joystick, game pad, data port, and the like. These and other I/O devices may be coupled to processor 807 via I/O interfaces 812 which may be coupled to system bus 808, and/or may be coupled by other interfaces and bus structures, such as a parallel port, game port, universal serial bus (“USB”), fire wire, infrared (“IR”) port, and the like.

Computing device 801 may operate in a networked environment via communications connections to one or more remote computing devices through one or more cellular networks, wireless networks, local area networks (“LAN”), wide area networks (“WAN”), storage area networks (“SAN”), the Internet, radio links, optical links and the like. Computing device 801 may be coupled to a network via network adapter 813 or the like, or, alternatively, via a modem, digital subscriber line (“DSL”) link, integrated services digital network (“ISDN”) link, Internet link, wireless link, or the like.

Communications connection 814, such as a network connection, typically provides a coupling to communications media, such as a network. Communications media typically provide computer-readable and computer-executable instructions, data structures, files, program modules and other data using a modulated data signal, such as a carrier wave or other transport mechanism. The term “modulated data signal” typically means a signal that has one or more of its characteristics set or changed in such a manner as to encode information in the signal. By way of example, and not limitation, communications media may include wired media, such as a wired network or direct-wired connection or the like, and wireless media, such as acoustic, radio frequency, infrared, or other wireless communications mechanisms.

Power source 890, such as a battery or a power supply, typically provides power for portions or all of computing environment 800. In the case of the computing environment 800 being a mobile device or portable device or the like, power source 890 may be a battery. Alternatively, in the case computing environment 800 is a computer or server or the like, power source 890 may be a power supply designed to connect to an alternating current (“AC”) source, such as via a wall outlet.

Some mobile devices may not include many of the components described in connection with FIG. 8. For example, an electronic badge may be comprised of a coil of wire along with a simple processing unit 807 or the like, the coil configured to act as power source 890 when in proximity to a card reader device or the like. Such a coil may also be configure to act as an antenna coupled to the processing unit 807 or the like, the coil antenna capable of providing a form of communication between the electronic badge and the card reader device. Such communication may not involve networking, but may alternatively be general or special purpose communications via telemetry, point-to-point, RF, IR, audio, or other means. An electronic card may not include display 802, I/O device 803, or many of the other components described in connection with FIG. 8. Other mobile devices that may not include many of the components described in connection with FIG. 8, by way of example and not limitation, include electronic bracelets, electronic tags, implantable devices, and the like.

Those skilled in the art will realize that storage devices utilized to provide computer-readable and computer-executable instructions and data can be distributed over a network. For example, a remote computer or storage device may store computer-readable and computer-executable instructions in the form of software applications and data. A local computer may access the remote computer or storage device via the network and download part or all of a software application or data and may execute any computer-executable instructions. Alternatively, the local computer may download pieces of the software or data as needed, or distributively process the software by executing some of the instructions at the local computer and some at remote computers and/or devices.

Those skilled in the art will also realize that, by utilizing conventional techniques, all or portions of the software's computer-executable instructions may be carried out by a dedicated electronic circuit such as a digital signal processor (“DSP”), programmable logic array (“PLA”), discrete circuits, and the like. The term “electronic apparatus” may include computing devices or consumer electronic devices comprising any software, firmware or the like, or electronic devices or circuits comprising no software, firmware or the like.

The term “firmware” typically refers to executable instructions, code, data, applications, programs, or the like maintained in an electronic device such as a ROM. The term “software” generally refers to executable instructions, code, data, applications, programs, or the like maintained in or on any form of computer-readable media. The term “computer-readable media” typically refers to system memory, storage devices and their associated media, and the like.

In view of the many possible embodiments to which the principles of the present invention and the forgoing examples may be applied, it should be recognized that the examples described herein are meant to be illustrative only and should not be taken as limiting the scope of the present invention. Therefore, the invention as described herein contemplates all such embodiments as may come within the scope of the following claims and any equivalents thereto.

1. A system for mapping the location of devices, the devices being part of a federation of devices, the system operating at least in part on a receiving device of the devices, the system comprising:
a receiving means operable to receive a remote location data (“RLD”) data structure from each of the devices; and
a relative location processor coupled to the receiver means and operable to:
process the RLD data structure, and
create a local location table (“LLT”) data structure such that the LLT data structure indicates a calculated location of each of the devices relative to the receiving device.

2. The system of claim 1 further comprising:
the receiving means operable to receive a remote location table (“RLT”) data structure from each of the devices; and
a mapping processor coupled to the receiving means and operable to:
process the LLT data structure and the RLT data structure from each of the devices, and
create a map data structure such that the map data structure indicates a location of each of the devices relative to the other devices of the federation of devices.

3. The system of claim 1 further comprising a data store operable to store the LLT data structure and the map data structure.

4. The system of claim 1 further comprising a sending means operable to send the LLT data structure to the devices.

5. The system of claim 1 further comprising the sending means operable to send a local location data (“LLD”) data structure to the devices.

6. The system of claim 1 wherein the RLD data structure includes device identification information identifying a device from which the RLD data structure was sent.

7. The system of claim 6 wherein the RLD data structure includes location information such that the relative location processor can determine the calculated location of the device from which the RLD data structure was sent relative to the first device.

8. The system of claim 7 wherein the LLT data structure includes the calculated location associated with the device identification information.

9. A method for creating a location table (“LT”) data structure including locations of devices, the devices being part of a federation of devices, relative to a receiving device of the devices, the method comprising:
receiving a remote location data (“RLD”) data structure from a sending device of the devices, the RLD data structure including device identification information and relative location information;
determining if a record associated with the sending device already exists in the LLT data structure, and
if the record exists, updating the record with relative location information from the RLD data structure, else
if the record does not exist, creating the record including the relative location information and the device identification information from the RLD data structure;
determining a calculated location of the sending device, using the relative location information, relative to the receiving device; and
adding the calculated location to the record.

10. The method of claim 9 further comprising sending the LT data structure to the devices.

11. The method of claim 9 wherein the RLD data structure further includes absolute location information.

12. The method of claim 111 wherein the absolute location information is included in the record.

13. The method of claim 11 wherein the determining a calculated location makes use of the absolute location information.

14. The method of claim 9 embodied as computer-executable instruction on computer-readable media.

15. A method for creating a map of devices, the devices being part of a federation of devices, the method comprising:
receiving a remote location table (“RLT”) data structure from each of the devices of the federation of devices; and
creating a map by making use of device identification data and relative location data of the RLT data structure from each of the devices of the federation of devices such that the map indicates a location of each of the devices relative to the other devices of the federation of devices.

16. The method of claim 15 further comprising:
determining if a minimum number of RLT data structures have been received;
if the minimum number of RLT data structures has been received then creating the map.

17. The method of claim 15 further comprising:
determining if the map already exists; and
if the map already exists, then updating the map by making use of the device identification data and the relative location data of the RLT data structure from each of the devices of the federation of devices.

18. The method of claim 15 further comprising:
determining if there is absolute location data in at least one of the RLT data structures from the devices of the federation of devices;
if there is absolute location data, then creating the map by making use of the absolute location data such that the map indicates an absolute location of at least one of the devices of the federation of devices.

19. The method of claim 15 further comprising graphically displaying the map on a display means.

20. The method of claim 15 embodies as computer-readable instructions on computer-readable media.
